(19) United States
(12) Patent Application Publication
(10) Pub. No.: US 2022/0242984 A1
(43) Pub. Date: Aug. 4, 2022

(54) COMPOSITION, METHOD OF PRODUCING POLYMER USING THE COMPOSITION, AND POLYMER PRODUCED THEREBY

(71) Applicant: Samsung Display Co., Ltd., Yongin-si (KR)

(72) Inventors: Onnuri Kim, Yongin-si (KR); Younghye Son, Yongin-si (KR); Sanggu Lee, Yongin-si (KR)

(21) Appl. No.: 17/451,399

(22) Filed: Oct. 19, 2021

(30) Foreign Application Priority Data
Jan. 26, 2021 (KR) 10-2021-0011054

(51) Int. Cl. C08F 220/20; C08F 220/18; C08F 220/14; C08F 2/48; C08F 222/10; C08G 18/75; C09J 7/38; C09D 11/107

(52) U.S. Cl. CPC C08F 220/20; C08F 220/1806; C08F 220/1808; C08F 220/14; C08F 220/1804; C09J 2433/00; C08F 222/102; C08G 18/755; C09J 7/385; C09D 11/107; C08F 2/48

(57) ABSTRACT

Provided are a composition including a monomer, a photoinitiator, and a cross-linking agent, the composition having a viscosity suitable for inkjet coating at room temperature, wherein a polymer produced through cross-linking of the compound has a modulus value at 60° C. (G′_{60° C.}) of about 20 KPa to about 70 KPa; a method of producing a polymer using the composition; and a polymer produced using the production method.

### CROSS-REFERENCE TO RELATED APPLICATION

This application claims priority to and the benefit of Korean Patent Application No. 10-2021-0011054, filed on Jan. 26, 2021, in the Korean Intellectual Property Office, the entire contents of which are hereby incorporated by reference.

### BACKGROUND

### 1. Field

One or more embodiments of the present disclosure relate to a composition, a method of preparing a polymer using the same, and a polymer prepared from the same.

### 2. Description of the Related Art

Pressure-sensitive adhesives (PSAs) used for adhesion between a film, panel, and window of a foldable display mainly relieve modular flexibility and relieve stress during folding.

PSAs have many problems or issues that result in them not being applied to a variety of product groups. For example, a PSA may have a problem or issue that pre-cutting should fit to a film which the PSA is to adhere to, which is expensive.

### SUMMARY

One or more embodiments of the present disclosure include a composition with which a polymer film is formed in any suitable shape, a method of producing a polymer using the same, and a polymer produced thereby.

Additional aspects of embodiments will be set forth in part in the description which follows and, in part, will be apparent from the description, or may be learned by practice of the presented embodiments of the disclosure.

According to one or more embodiments, provided is a composition comprising a monomer, a photoinitiator, and a cross-linking agent, wherein the composition has a viscosity suitable for inkjet-coating (e.g., inkjet printing) at room temperature, and polymer produced through cross-linking of the composition has a modulus value at 60° C. (G′_{60° C.}) of 20 KPa to 70 KPa.

According to one or more embodiments, a method of producing a polymer includes inkjet-coating the composition, primary cross-linking the coated composition to form a primary cross-linked product, and secondary cross-linking the primary cross-linked to form a primary and secondary cross-linked product.

According to one or more embodiments, provided is a polymer produced by the producing method.

The above and other aspects and features of certain embodiments of the disclosure will be more apparent from the following description.

### DETAILED DESCRIPTION

Reference will now be made in more detail to embodiments of the present disclosure. In this regard, the present embodiments may have different forms and should not be construed as being limited to the descriptions set forth herein. Accordingly, the embodiments are merely described below to explain aspects of embodiments of the present description. As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

Pressure-sensitive adhesives that are used in foldable displays are expensive, and there is an inconvenience from a process of pre-cutting the pressure-sensitive adhesives to fit to a film to which the pressure-sensitive adhesives are to be adhered. The pre-cutting of the pressure-sensitive adhesives results in waste of the portions of the pressure-sensitive that are cut off, thereby increasing manufacturing costs.

According to one or more embodiments, a composition may include a monomer, a photoinitiator, and a cross-linking agent, wherein the composition may have a viscosity suitable for inkjet-coating (e.g., inkjet printing) at room temperature, and a polymer produced through cross-linking of the composition may have a modulus value at 60° C. (G′_{60° C.}) of about 20 KPa to about 70 KPa.

The composition according to one or more embodiments may have a viscosity suitable for inkjet-coating (e.g., inkjet printing) at room temperature. Thus, the composition according to one or more embodiments may be inkjet-coated (e.g., inkjet printed) on a film to be adhered without the need for pre-cutting a pressure-sensitive adhesive film to fit to the film to which the pressure-sensitive adhesive film is to be adhered. Due to the inkjet process, the film to be adhered may have any suitable shape or shapes.

In one or more embodiments, a polymer produced through cross-linking of the composition has a modulus value at 60° C. (G′_{60° C.}) of about 20 KPa to about 70 KPa. When the polymer has a modulus value at 60° C. (G′_{60° C.}) within this range, the polymer may exhibit an adhesive strength of 0.5 kgf/inch or greater at a high temperature, for example, at a temperature of 60° C. and thus is suitable for use in foldable displays.

In one or more embodiments, the composition may have a viscosity at room temperature of about 10 cP to about 50 cP. When the composition has a viscosity at room temperature of less than 10 cP, a defect may occur during rapid ink-jetting (e.g., during inkjet printing). When the composition has a viscosity greater than 50 cP at room temperature, inkjet discharging may be impossible to perform (or may be unsuitably difficult to perform).

In one or more embodiments, a cross-linking density of the polymer may be about 0.0045 dyne/cm² to about 0.0060 dyne/cm². When the polymer has a cross-linking density of 0.0045 dyne/cm² to 0.0060 dyne/cm², the polymer may have a modulus value at 60° C. (G′_{60° C.}) of about 20 KPa to about 70 KPa.

In one or more embodiments, the polymer may have a modulus value at −20° C. (G′_{-20° C.}) of about 100 KPa to about 300 KPa. To be suitable for foldable display operation at a low temperature, the polymer may have a modulus value at −20° C. (G′_{-20° C.}) within this range.

In one or more embodiments, the composition may be used for adhesion between a window of a foldable display and a film. For example, the composition may be coated onto a film, which is to be adhered, to a thickness of 0.1 mm to 0.5 mm and primarily cured (e.g., the composition may undergo a primary cross-linking to form a primary cross-linked product), and thereafter bonded to a window of a display and then secondarily cured (e.g., the primary cross-linked product may undergo a secondary cross-linking to form a primary and secondary cross-linked product), so that the window and the film adhere to each other.

In one or more embodiments, the polymer may have an adhesive strength at 60° C. of 0.5 kgf/inch or greater. When the adhesive strength at 60° C. is less than 0.5 kgf/inch, the adhesion between the window and the film may weaken with repeated folding, and thus, the window and the film may be separated from each other. For example, the polymer may have an adhesive strength at 60° C. of 0.5 kgf/inch to 2.0 kgf/inch. When the adhesive strength thereof at 60° C. is greater than 2.0 kgf/inch, the polymer cannot, or does not sufficiently, absorb stress during folding and break, which may cause defects.

In one or more embodiments, the cross-linking (e.g., the primary cross-linking or the secondary cross-linking) may be performed by light. For example, the cross-linking may be performed by way of ultraviolet (UV) rays. For example, the cross-linking may be performed by irradiating the composition or the primary cross-linked product with UV rays having a wavelength of 10 nm to 400 nm. For example, the cross-linking may be performed by way of extreme UV rays having a wavelength of 10 nm to 121 nm. For example, the cross-linking may be performed by way of vacuum UV rays having a wavelength of 10 nm to 200 nm. For example, the cross-linking may be performed by way of hydrogen Lyman-alpha radiation at a wavelength of 121 nm to 122 nm. For example, the cross-linking may be performed by way of far UV rays having a wavelength of 122 nm to 200 nm. For example, the cross-linking may be performed by way of UV rays having a wavelength of 200 nm to 300 nm. For example, the cross-linking may be performed by way of near UV rays having a wavelength of 300 nm to 400 nm. For example, the cross-linking may be performed by way of ultraviolet C (UVC) rays having a wavelength of 100 nm to 280 nm. For example, the cross-linking may be performed by way of ultraviolet B (UVB) rays having a wavelength of 280 to 315 nm. For example, the cross-linking may be performed by way of ultraviolet A (UVA) rays having a wavelength of 315 to 400 nm.

In one or more embodiments, the composition may include a photoinitiator which initiates polymerization by way of light (e.g., by irradiating the composition or primary cross-linked product with light). The photoinitiator may be any suitable compound that initiates polymerization by way of light, for example, UV light.

The photoinitiator may include, for example, 4-acryloxybenzophenone, 2,2-dimethoxy-2-phenylacetophenone, 2-hydroxy-2-methyl-1-phenyl-1-propan-1-one, and/or the like.

In one or more embodiments, the cross-linking may include a primary cross-linking and a secondary cross-linking. For example, the cross-linking may include: a primary cross-linking performed with UV light having a wavelength of 10 nm to 400 nm for 0.1 to 4 seconds; and a secondary cross-linking performed with UV light having a wavelength of 10 nm to 400 nm for 0.1 to 4 seconds.

For example, the composition may be inkjet-coated (e.g., inkjet printed) on a film to a thickness of 0.1 mm to 0.5 mm, and subjected to the primary cross-linking performed with UV light having a wavelength of 10 to 400 nm for 0.1 to 4 seconds (e.g., to form a primary cross-linked product), and then a resulting polymer formed through the primary cross-linking of the composition (e.g., the primary cross-linked product) is combined with a different film and subjected to the secondary cross-linking performed with UV light having a wavelength of 10 to 400 nm for 0.1 to 4 seconds (e.g., to form a primary and secondary cross-linked product), and thus, different films adhere to each other (e.g., by way of the primary and secondary cross-linked product).

The composition may include a monomer, a photoinitiator, and a cross-linking agent, wherein the amount of the photoinitiator may be about 0.05 parts to about 5 parts by weight with respect to 100 parts by weight of the monomer. For example, the amount of the photoinitiator may be about 0.1 parts to about 2 parts by weight with respect to 100 parts by weight of the monomer.

The monomer included in the composition according to one or more embodiments may be any suitable monomer that enables the composition to have a viscosity suitable for inkjet coating (e.g., inkjet printing) at room temperature and the polymer formed through the cross-linking to have a modulus value at 60° C. (G′_{60° C.}) to be within a range of about 20 KPa to about 70 KPa.

In one or more embodiments, the composition may not include a solvent.

In one or more embodiments, the monomer may include an acrylate-based monomer. For example, the monomer may include a C₁-C₃₀ alkyl (meth)acrylate, an OH group-including C₁-C₃₀ alkyl (meth)acrylate, a C₆-C₃₀ aryl (meth)acrylate, an OH group-including C₆-C₃₀ aryl (meth)acrylate, or any combinations thereof.

The alkyl group and the aryl group may be substituted or unsubstituted. For example, the alkyl group and the aryl group may be substituted with a cyclic ether group, aryl group, and/or the like. The alkyl group may be linear or branched.

When an OH group-containing C₁-C₃₀ alkyl (meth)acrylate or C₁-C₃₀ aryl (meth)acrylate is used, cross-linking density may be relatively high even though a cross-linking reaction occurs for a short time, and the cross-linking density may be relatively further increased even though the cross-linking reaction occurs for a short time by controlling the number of included OH groups. By controlling the cross-linking density to be relatively high, it is possible to control a high-temperature modulus of the polymer being produced, for example, a modulus value at 60° C. falls within a suitable or desired range.

In one or more embodiments, the OH group-containing C₁-C₃₀ alkyl (meth)acrylate and the OH group-containing C₆-C₃₀ aryl (meth)acrylate may include one to five OH groups.

For example, the monomer may include a C₁-C₃₀ alkyl (meth)acrylate including one OH group, a C₁-C₃₀ aryl (meth)acrylate including one OH group, or any combinations thereof. For example, the monomer may include a C₁-C₃₀ alkyl (meth)acrylate including one OH group, a C₁-C₃₀ alkyl (meth)acrylate including two OH groups, a C₁-C₃₀ alkyl (meth)acrylate including three OH groups, a C₁-C₃₀ aryl (meth)acrylate including one OH group, a C₁-C₃₀ aryl (meth)acrylate including two OH groups, a C₁-C₃₀ aryl (meth)acrylate including three OH groups, or any combinations thereof.

For example, the monomer may include a C₁-C₃₀ alkyl (meth)acrylate, a C₁-C₃₀ alkyl (meth)acrylate including one OH group, a C₁-C₃₀ alkyl (meth)acrylate including two OH groups, or any combinations thereof.

For example, the monomer may include 2-ethylhexyl (meth)acrylate, ethyl (meth)acrylate, methyl (meth)acrylate, n-propyl (meth)acrylate, isopropyl (meth)acrylate, pentyl (meth)acrylate, n-octyl (meth)acrylate, isooctyl (meth)acrylate, isononyl (meth)acrylate, n-butyl (meth)acrylate, isobutyl (meth)acrylate, n-hexyl (meth)acrylate, n-nonyl (meth)acrylate, isoamyl (meth)acrylate, n-decyl (meth)acrylate, isodecyl (meth)acrylate, dodecyl (meth)acrylate, isobornyl (meth)acrylate, cyclohexyl (meth)acrylate, phenyl (meth)acrylate, benzyl (meth)acrylate, isostearyl (meth)acrylate, 2-methylbutyl (meth)acrylate, 2-hydroxyethyl (meth)acrylate, 2-hydroxypropyl (meth)acrylate, 4-hydroxybutyl (meth)acrylate, dihydroxyhexyl (meth)acrylate, tetrahydrofurfuryl (meth)acrylate, or any combinations thereof.

In one or more embodiments, the cross-linking agent may include diacryl, isocyanate, or any combinations thereof.

In one or more embodiments, the amount of the cross-linking agent may be about 50 parts to about 90 parts by weight with respect to 100 parts by weight of the monomer. When the amount of the cross-linking agent is within this range, a polymer produced through the reaction between the monomer and the photoinitiator may have a modulus value at 60° C. of 20 KPa to 70 KPa.

In one or more embodiments, the cross-linking agent may include a single cross-linking agent or two different cross-linking agents.

When two different cross-linking agents are used, the two cross-linking agents may both be diacryls or isocyanates, or one may be a diacryl and the other may be an isocyanate.

In the case where the two different cross-linking agents include a diacryl-based cross-linking agent and an isocyanate-based cross-linking agent, cross-liking density may be controlled by controlling a ratio between the diacryl-based cross-linking agent and the isocyanate-based cross-linking agent. By controlling the cross-linking density to be relatively high, it is possible to control a high-temperature modulus of the polymer being produced, for example, a modulus value at 60° C. falls within a suitable or desired range.

In one or more embodiments, the cross-linking agent may include a diacryl-based cross-linking agent and an isocyanate-based cross-linking agent, and a weight ratio between the diacryl-based cross-linking agent and the isocyanate-based cross-linking agent may be about 0.3:1 to about 1:0.3. When a diacryl-based cross-linking agent and an isocyanate-based cross-linking agent, as a two-cross-linking agent system, are used within this range, by controlling the cross-linking density, it is possible to control a high-temperature modulus value of the polymer being produced to fall within a suitable or desired range. For example, a weight ratio between the diacryl-based cross-linking agent and the isocyanate-based cross-linking agent may be about 0.7:1 to about 1:0.7.

In one or more embodiments, the cross-linking agent may include ethylene diacrylate, 3,3,5-trimethyl-5-(isocyanatomethyl) cyclohexyl isocyanate, or any combinations thereof.

According to another aspect of an embodiment, a method of producing a polymer may include inkjet coating (e.g., inkjet printing) the composition, primary cross-linking the coated composition (e.g., to form a primary cross-linked product), and secondary cross-linking a product of the primary cross-linking (e.g., secondary cross-linking the primary cross-linked product to form a primary and second cross-linked product).

For further details of the composition, the descriptions above may be referred to.

The composition is suitable for inkjet processing (e.g., inkjet printing) and rapid curing (e.g., cross-linking).

In one or more embodiments, the primary cross-linking and the secondary cross-linking may each independently be performed for 0.1 seconds to 4 seconds.

For example, the cross-linking may include: a primary cross-linking performed with UV light having a wavelength of 10 to 400 nm for 0.1 to 4 seconds; and a secondary cross-linking performed with UV light having a wavelength of 10 to 400 nm for 0.1 to 4 seconds.

For example, the composition may be inkjet-coated (e.g., inkjet printed) on a window and subjected to a primary cross-linking performed with UV light having a wavelength of 10 to 400 nm for 0.1 to 4 seconds, and then a resulting polymer formed through the primary cross-linking of the composition (e.g., a primary cross-linked product) is combined with a lower film and subjected to secondary cross-linking performed with UV light having a wavelength of 10 to 400 nm for 0.1 to 4 seconds, thereby producing a polymer (e.g., a primary and secondary cross-linked product) that adheres the lower film to the window.

The polymer produced using the production method described above may have a modulus value at 60° C. (G′_{60° C.}) of 20 KPa to 70 KPa. Due to having a high-temperature modulus within this range, the polymer may have an adhesive strength at 60° C. of 0.5 kgf/inch or greater.

### General Definition of at Least Some of the Substituents

As used herein, the term “C₁-C₃₀ alkyl group” means a C₁-C₆₀ linear or branched monovalent aliphatic hydrocarbon group, and examples thereof include a methyl group, an ethyl group, an n-propyl group, an isopropyl group, an n-butyl group, a sec-butyl group, an isobutyl group, a tert-butyl group, an n-pentyl group, a tert-pentyl group, a neopentyl group, an isopentyl group, a sec-pentyl group, a 3-pentyl group, a sec-isopentyl group, an n-hexyl group, an isohexyl group, a sec-hexyl group, a tert-hexyl group, an n-heptyl, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, a tert-decyl group, and the like.

As used herein, the term “C₆-C₃₀ aryl group” refers to a monovalent group with a C₅-C₃₀ carbocyclic aromatic system. Examples of the C₆-C₆₀ aryl group include a phenyl group, a pentalenyl group, a naphthyl group, an azulenyl group, an indacenyl group, an acenaphthyl group, a phenalenyl group, a phenanthrenyl group, an anthracenyl group, a fluoranthenyl group, a triphenylenyl group, a pyrenyl group, a chrysenyl group, a perylenyl group, a pentaphenyl group, a heptalenyl group, a naphthacenyl group, a pisenyl group, a hexaenyl group, a pentacenyl group, a rubicenyl group, a coronenyl group, an ovalenyl group, and the like. When a C₆-C₃₀ aryl group includes two or more rings, the two or more rings may be fused to each other (e.g., combined together).

One or more embodiments of a composition, a polymer production method, and a polymer film according to embodiments will now be described in more detail with reference to the following examples, but the present disclosure is not limited thereto.

### EXAMPLES

### Preparation of Composition

### Composition 1 (Pressure-Sensitive Adhesive)

Polyethylene glycol diacrylate as an oligomer was added to 40 parts by weight of n-hexyl acrylate, 30 parts by weight of methyl methacrylate, 10 parts by weight of 4-hydroxybutyl acrylate, 10 parts by weight of 2-ethylhexyl acrylate, and 10 parts by weight of n-butyl acrylate, which were monomers, to prepare Composition 1.

### Composition 2

70 parts by weight of ethylene diacrylate as a cross-linking agent (with respect to 100 parts by weight of the total monomers) and 0.5 parts by weight of 4-acryloxybenzophenone as a photoinitiator (with respect to 100 parts by weight of the total monomers) were added to 70 parts by weight of n-hexyl acrylate, 20 parts by weight of 2-ethylhexyl acrylate, and 10 parts by weight of urethane acrylate, which were monomers, to prepare Composition 2.

### Composition 3

60 parts by weight of ethylene diacrylate as a cross-linking agent (with respect to 100 parts by weight of the total monomers) and 0.5 parts by weight of 4-acryloxybenzophenone as a photoinitiator (with respect to 100 parts by weight of the total monomers) were added to 70 parts by weight of 4-hydroxybutyl acrylate and 30 parts by weight of 2-ethylhexyl acrylate, which were monomers, to prepare Composition 3.

### Composition 4

60 parts by weight of ethylene diacrylate as a cross-linking agent (with respect to 100 parts by weight of the total monomers) and 0.5 parts by weight of 4-acryloxybenzophenone as a photoinitiator (with respect to 100 parts by weight of the total monomers) were added to 70 parts by weight of 4-hydroxybutyl acrylate, 20 parts by weight of dihydroxyhexyl acrylate, and 10 parts by weight of 2-ethylhexyl acrylate, which were monomers, to prepare Composition 4.

### Composition 5

Ethylene diacrylate and 3,3,5-trimethyl-5-(isocyanatomethyl) cyclohexyl isocyanate as cross-linking agents were added to 70 parts by weight of 4-hydroxybutyl acrylate, 20 parts by weight of n-hexyl acrylate and 10 parts by weight of 2-ethylhexyl acrylate, which were monomers.

A total weight of the cross-linking agents was 60 parts by weight with respect to 100 parts by weight of the total monomers, and a weight ratio between the ethylene diacrylate and the 3,3,5-trimethyl-5-(isocyanatomethyl) cyclohexyl isocyanate was 4:9.

0.5 parts by weight of 4-acryloxybenzophenone as a photoinitiator (with respect to 100 parts by weight of the total monomers) was added thereto to prepare Composition 5.

### Composition 6

Ethylene diacrylate and 3,3,5-trimethyl-5-(isocyanatomethyl)cyclohexyl isocyanate as cross-linking agents were added to 70 parts by weight of 4-hydroxybutyl acrylate, 20 parts by weight of n-hexyl acrylate, and 10 parts by weight of tetrahydrofurfuryl acrylate, which were monomers.

A total weight of the cross-linking agents was 60 parts by weight with respect to 100 parts by weight of the total monomers, and a weight ratio between the ethylene diacrylate and the 3,3,5-trimethyl-5-(isocyanatomethyl) cyclohexyl isocyanate was 10:3.

0.7 parts by weight of 2,2-dimethoxy-2-phenylacetophenone as a photoinitiator (with respect to 100 parts by weight of the total monomers) was added thereto to prepare Composition 6.

### Composition 7

Ethylene diacrylate and 3,3,5-trimethyl-5-(isocyanatomethyl)cyclohexyl isocyanate as cross-linking agents were added to 70 parts by weight of 4-hydroxybutyl acrylate and 30 parts by weight of 2-ethylhexyl acrylate, which were monomers.

A total weight of the cross-linking agents was 70 parts by weight with respect to 100 parts by weight of the total monomers, and a weight ratio between the ethylene diacrylate and the 3,3,5-trimethyl-5-(isocyanatomethyl) cyclohexyl isocyanate was 5:9.

0.6 parts by weight of 2,2-dimethoxy-2-phenylacetophenone as a photoinitiator (with respect to 100 parts by weight of the total monomers) was added thereto to prepare Composition 7.

### Composition 8

Ethylene diacrylate and 3,3,5-trimethyl-5-(isocyanatomethyl)cyclohexyl isocyanate as cross-linking agents were added to 70 parts by weight of 4-hydroxybutyl acrylate and 30 parts by weight of 2-ethylhexyl acrylate, which were monomers.

A total weight of the cross-linking agents was 60 parts by weight with respect to 100 parts by weight of the total monomers, and a weight ratio between the ethylene diacrylate and the 3,3,5-trimethyl-5-(isocyanatomethyl) cyclohexyl isocyanate was 7:9.

0.5 parts by weight of 2-hydroxy-2-methyl-1-phenyl-1-propan-1-one (with respect to 100 parts by weight of the total monomers) as a photoinitiator was added thereto to prepare Composition 8.

### Composition 9

Ethylene diacrylate and 3,3,5-trimethyl-5-(isocyanatomethyl)cyclohexyl isocyanate as cross-linking agents were added to 70 parts by weight of 4-hydroxybutyl acrylate and 30 parts by weight of 2-ethylhexyl acrylate, which were monomers.

A total weight of the cross-linking agents was 60 parts by weight with respect to 100 parts by weight of the total monomers, and a weight ratio between the ethylene diacrylate and the 3,3,5-trimethyl-5-(isocyanatomethyl) cyclohexyl isocyanate was 1:1.

0.6 parts by weight of 4-acryloxybenzophenone as a photoinitiator (with respect to 100 parts by weight of the total monomers) was added thereto to prepare Composition 9.

### Composition 10

Ethylene diacrylate and 3,3,5-trimethyl-5-(isocyanatomethyl)cyclohexyl isocyanate as cross-linking agents were added to 70 parts by weight of n-octyl acrylate, 20 parts by weight of 2-ethylhexyl acrylate, and 10 parts by weight of n-hexyl acrylate, which were monomers.

A total weight of the cross-linking agents was 60 parts by weight with respect to 100 parts by weight of the total monomers, and a weight ratio between the ethylene diacrylate and the 3,3,5-trimethyl-5-(isocyanatomethyl) cyclohexyl isocyanate was 1:1.

0.6 parts by weight of 4-acryloxybenzophenone as a photoinitiator (with respect to 100 parts by weight of the total monomers) was added thereto to prepare Composition 10.

### Composition 11

3,3,5-trimethyl-5-(isocyanatomethyl) cyclohexyl isocyanate as a cross-linking agent was added to 70 parts by weight of 2-hydroxybutyl acrylate and 30 parts by weight of n-hexyl acrylate, which were monomers (60 parts by weight of the 3,3,5-trimethyl-5-(isocyanatomethyl) cyclohexyl isocyanate added with respect to 100 parts by weight of the total monomers).

0.6 parts by weight of 4-acryloxybenzophenone as a photoinitiator (with respect to 100 parts by weight of the total monomers) was added thereto to prepare Composition 11.

### Composition 12

3,3,5-trimethyl-5-(isocyanatomethyl) cyclohexyl isocyanate as a cross-linking agent was added to 70 parts by weight of 4-hydroxybutyl acrylate, 20 parts by weight of 2-ethylhexyl acrylate, and 10 parts by weight of n-hexyl acrylate, which were monomers (60 parts by weight of the 3,3,5-trimethyl-5-(isocyanatomethyl) cyclohexyl isocyanate added with respect to 100 parts by weight of the total monomers).

0.6 parts by weight of 4-acryloxybenzophenone as a photoinitiator (with respect to 100 parts by weight of the total monomers) was added thereto to prepare Composition 12.

### Composition Viscosity Evaluation

Viscosities of Compositions 2 to 12 were measured using a viscometer (Sine-Wave Vibro Viscometer, SV-1A, A&D Instruments) at room temperature to evaluate ink jetting performance. The results are shown in Table 1.

TABLE 1

| | Viscosity | Jetting | | |
|---|---|---|---|---|
| Composition | (cP) | performance | Dormancy¹⁾ | Rapid jetting²⁾ |
| 2 | 32 | OK | OK | OK |
| 3 | 12 | OK | OK | OK |
| 4 | 30 | OK | OK | OK |
| 5 | 28 | OK | OK | OK |
| 6 | 15 | OK | OK | OK |
| 7 | 22 | OK | OK | OK |
| 8 | 20 | OK | OK | OK |
| 9 | 19 | OK | OK | OK |
| 10 | 25 | OK | OK | OK |
| 11 | 54 | NG | NG | NG |
| 12 | 4 | OK | OK | NG |

¹⁾Dormancy: Jetting-suspension-jetting processing performance confirmation
²⁾Confirmation of jettability at high frequency (5.3 kHz)

Referring to Table 1, it was found that Compositions 11 and 12 having a high viscosity or a low viscosity, respectively, were not suitable for an inkjet process.

Evaluation of Cross-Linking Density, Modulus, and Adhesive Strength

Compositions 1 to 10 was coated on a release film to a thickness of 500 μm and bonded with another release film to form a film/Composition/film structure, and thereafter, each Composition was cured with UV light (365 nmₘₐₓ) to form a polymer film.

The cured material was cut with an 8-mm diameter-hole punch to prepare samples for evaluation. A modulus of each sample was measured using a rheometer (DHR3, TA instruments). The moduli of each polymer film according to temperatures and the cross-linking density thereof were measured and shown in Table 2.

The cross-linking density (ue, dynes/cm²) was obtained using Equation (1).

(1)

E′: Rubbery plateau modulus,

T: Temperature

The cross-linking density may be measured using any suitable method available in the art. For further details of an example thereof, refer to the paper [Elastomers and Composites 54, 209-219 (2019)], the entire contents of which are incorporated herein by reference.

After Compositions 2 to 10 were separately inkjet-coated onto a window to a thickness of 35 μm and subjected to cross-linking with UV light (365 nmₘₐₓ) for 1 second, a resulting film was combined with a lower film to manufacture a window/polymer film/lower film structure.

The window/polymer film/lower film was exposed to UV (365 nmₘₐₓ) light for 2 seconds to be further cross-linked, so that the window adhered to the lower film.

The force to peel off the lower film from the window/polymer film/lower film structure (adhesive strength) was measured and shown in Table 2.

Compositions 11 and 12 were not suitable for inkjet processing.

TABLE 2

| | | | | Cross- | Adhesive strength | | |
|---|---|---|---|---|---|---|---|
| | | | | linking | (kgf/inch) | | |
| | Modulus (G′[Pa]) | | | density | | | @60° C. |
| Composition | @−20° C. | @25° C. | @60° C. | (dyne/cm²) | @25° C. | @60° C. | RH93%¹⁾ |
| 1 | 100506 | 40668 | 32322 | 0.0052 | 1.11 | 0.96 | 0.35 |
| 2 | 35103 | 8592 | 10008 | 0.0034 | 0.16 | 0.013 | — |
| 3 | 257803 | 32575 | 23708 | 0.0046 | 0.89 | 0.50 | 0.40 |
| 4 | 282034 | 38135 | 30283 | 0.0051 | 1.07 | 0.65 | 0.45 |
| 5 | 125043 | 36670 | 40802 | 0.0054 | 0.95 | 0.58 | 0.52 |
| 6 | 145492 | 33304 | 33733 | 0.0052 | 1.01 | 0.79 | 0.48 |
| 7 | 160466 | 25784 | 20309 | 0.0045 | 0.86 | 0.53 | 0.41 |
| 8 | 271514 | 34184 | 26840 | 0.0058 | 1.08 | 0.95 | 0.77 |
| 9 | 132518 | 38257 | 44035 | 0.0056 | 0.87 | 0.58 | 0.41 |
| 10 | 266329 | 36658 | 27753 | 0.0050 | 1.00 | 0.63 | 0.40 |

¹⁾RH93% refers to a 93% relative humidity.

Referring to Table 2, it was found that in the case where a polymer produced through cross-linking of a composition including monomers without an OH group had a modulus value at 60° C. (G′_{60° C.}) within a range of 20 KPa to 70 KPa, the high-temperature adhesive strength (@60 OC) was excellent (Composition 10).

In the cases of introducing OH groups into a monomer (Composition 3), including a monomer with an increased number of OH groups (Composition 4), and using two different cross-linking agents (with control of a ratio of the cross-linking agents) (Compositions 5 to 9), all the cases exhibited a modulus value at 60° C. (G′_{60° C.}) in a range of 20 KPa to 70 KPa and excellent high-temperature adhesive strength (@60° C.).

Meanwhile, a polymer produced through cross-linking of Composition 2 including monomers without OH groups was found to exhibit a modulus value at 60° C. (G′_{60° C.}) of about 10 KPa, which was not in the range of about 20 KPa to about 70 KPa, and inferior high-temperature adhesive strength (@60° C.).

Meanwhile, all the polymers produced from Compositions 3 to 10 exhibited a high-temperature adhesive strength at 93% relative humidity (@60° C. RH93%) of 0.40 or greater, which is better than the adhesive strength (@60° C. RH93%) of the polymer produced from Composition 1.

A polymer film in any suitable shape can be produced using the composition according to one or more embodiments, and thus, there is no need for pre-cutting a polymer film into a desired shape.

The composition may be easily coated by inkjet coating (e.g., inkjet printing), and the coated composition is suitable for a rapid curing system.

In addition, a polymer film produced by curing the coated composition may have a high modulus value suitable for foldable displays.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described, it will be understood by those of ordinary skill in the art that various changes in form and details may be made therein without departing from the spirit and scope as defined by the following claims, and equivalents thereof.

What is claimed is:

1. A composition comprising:
a monomer;
a photoinitiator; and
a cross-linking agent,
wherein the composition has a viscosity suitable for inkjet coating at room temperature, and
a polymer produced through cross-linking of the composition has a modulus value at 60° C. (G′_{60° C.}) of 20 KPa to 70 KPa.

2. The composition of claim 1, wherein the composition has a viscosity at room temperature of about 10 to about 50 cP.

3. The composition of claim 1, wherein a cross-linking density of the polymer is about 0.0045 to about 0.0060 dyne/cm².

4. The composition of claim 1, wherein a modulus value at −20° C. (G′_{-20° C.}) of the polymer is about 100 KPa to about 300 KPa.

5. The composition of claim 1, wherein an adhesive strength at 60° C. of the polymer is 0.5 kgf/inch or greater.

6. The composition of claim 1, wherein the composition is used for adhesion of a window to a film of a foldable display.

7. The composition of claim 1, wherein the cross-linking is performed by light.

8. The composition of claim 1, wherein the cross-linking comprises a primary cross-linking and a secondary cross-linking.

9. The composition of claim 8, wherein the primary cross-linking and the secondary cross-linking are each independently performed for 0.1 seconds to 4 seconds.

10. The composition of claim 1, wherein the monomer comprises an acrylate-based monomer.

11. The composition of claim 1, wherein the monomer comprises a C₁-C₃₀ alkyl (meth)acrylate, an OH group-containing C₁-C₃₀ alkyl (meth)acrylate, a C₆-C₃₀ aryl (meth)acrylate, an OH group-containing C₆-C₃₀ aryl (meth)acrylate, or any combinations thereof.

12. The composition of claim 11, wherein the OH group-containing C₁-C₃₀ alkyl (meth)acrylate and the OH group-containing C₆-C₃₀ aryl (meth)acrylate include one to five OH groups.

13. The composition of claim 1, wherein the monomer comprises 2-ethylhexyl (meth)acrylate, ethyl (meth)acrylate, methyl (meth)acrylate, n-propyl (meth)acrylate, isopropyl (meth)acrylate, pentyl (meth)acrylate, n-octyl (meth)acrylate, isooctyl (meth)acrylate, isononyl (meth)acrylate, n-butyl (meth)acrylate, isobutyl (meth)acrylate, n-hexyl (meth)acrylate, n-nonyl (meth)acrylate, isoamyl (meth)acrylate, n-decyl (meth)acrylate, isodecyl (meth)acrylate, dodecyl (meth)acrylate, isobornyl (meth)acrylate, cyclohexyl (meth)acrylate, phenyl (meth)acrylate, benzyl (meth)acrylate, isostearyl (meth)acrylate, 2-methylbutyl (meth)acrylate, 2-hydroxyethyl (meth)acrylate, 2-hydroxypropyl (meth)acrylate, 4-hydroxybutyl (meth)acrylate, dihydroxyhexyl (meth)acrylate, tetrahydrofurfuryl (meth)acrylate, or any combinations thereof.

14. The composition of claim 1, wherein the cross-linking agent comprises a diacryl-based cross-linking agent, an isocyanate-based cross-linking agent, or any combinations thereof.

15. The composition of claim 1, wherein the cross-linking agent comprises a diacryl-based cross-linking agent and an isocyanate-based cross-linking agent, and
a weight ratio between the diacyl-based cross-linking agent and the isocyanate-based cross-linking agent is about 0.3:1 to about 1:0.3.

16. The composition of claim 1, wherein the cross-linking agent comprises ethylene diacrylate, 3,3,5-trimethyl-5-(isocyanatomethyl) cyclohexyl isocyanate, or any combinations thereof.

17. A method of producing a polymer, the method comprising:
inkjet coating the composition of claim 1;
primary cross-linking the coated composition to form a primary cross-linked product; and
secondary cross-linking the primary cross-linked product to form a primary and secondary cross-linked product.

18. The method of claim 17, wherein the primary cross-linking and the secondary cross-linking are each independently performed for 0.1 seconds to 4 seconds.

19. A polymer produced by cross-linking a composition comprising a monomer, a photoinitiator, and a cross-linking agent,
wherein the composition has a viscosity suitable for inkjet coating at room temperature, and
the polymer has an adhesive strength of 0.40 or greater at 60° C. and a relative humidity of 93%.

20. The polymer of claim 19, wherein a modulus value at 60° C. (G′_{60° C.}) of the polymer is about 20 KPa to about 70 KPa.
